(19) United States
(12) Patent Application Publication
(10) Pub. No.: US 2026/0094002 A1
(43) Pub. Date: Apr. 2, 2026

(54) DYNAMIC CURRICULUM CONTROL METHOD BASED ON SEMI-SUPERVISED LEARNING FOR DEEP REINFORCEMENT LEARNING

(71) Applicant: Korea University Of Technology And Education Industry-University Cooperation Foundation, Cheonan-si (KR)

(72) Inventors: Won Tae KIM, Cheonan-si (KR); Deun Sol CHO, Cheonan-si (KR); Jae Min CHO, Cheonan-si (KR); Min Cheol LEE, Cheonan-si (KR)

(73) Assignee: Korea University Of Technology And Education Industry-University Cooperation Foundation, Cheonan-si (KR)

(21) Appl. No.: 18/955,747

(22) Filed: Nov. 21, 2024

(30) Foreign Application Priority Data
Oct. 2, 2024 (KR) 10-2024-0134077

(51) Int. Cl. G06N 3/096; G06N 3/092

(52) U.S. Cl. CPC G06N 3/096; G06N 3/092

(57) ABSTRACT

A method of generating a dynamic curriculum control model according to an embodiment may include generating a basic curriculum based on a curriculum generation model built based on semi-supervised learning; generating reconstructed curricula based on the basic curriculum; pre-training a learning tendency estimation model that predicts an agent learning tendency pattern of a reinforcement learning model based on the reconstructed curricula; obtaining agent learning tendency information of the reinforcement learning model; and generating a dynamic curriculum control model that reflects the agent learning tendency information by fine-tuning the learning tendency estimation model using a transfer training technique.

### CROSS-REFERENCE TO RELATED APPLICATION

The present application claims priority under 35 U.S.C. § 119(a) to Korean Patent Application No. 10-2024-0134077, filed on Oct. 2, 2024, which is incorporated herein by reference in its entirety.

### BACKGROUND

### 1. Field

One or more embodiments relate to a deep reinforcement learning (DRL) framework from among artificial intelligence (AI) and machine learning (ML), and more particularly, to a dynamic curriculum control method including a curriculum learning technique for improving the learning efficiency of a deep reinforcement learning agent.

### 2. Description of the Related Art

Reinforcement learning is one of the important research topics in the field of artificial intelligence and machine learning, and is used to develop a system that learns optimal actions on its own in a given environment. This technique involves a process in which an agent learns what consequences result from choosing an action in each situation while interacting with the environment.

In general, in reinforcement learning, an agent accumulates experience through repeated interactions with the environment and improves future actions based on that experience. In this process, the agent gradually discovers an optimal action strategy by using rewards provided by the environment for specific actions. This learning process may be applied to various fields of application, and is utilized in robotics, game artificial intelligence, autonomous driving, financial modeling, etc.

An important characteristic of reinforcement learning is that an agent may autonomously learn through interactions with the environment without prior knowledge. Through this, the agent acquires the ability to effectively deal with complex problem situations that are difficult to predict.

The above information may be provided as related art for the purpose of helping to understand the disclosure. No claim or determination is made as to whether any of the above contents can be applied as prior art related to the disclosure.

### SUMMARY

A computer-implemented method of generating a dynamic curriculum control model according to an embodiment may include generating a basic curriculum based on a curriculum generation model built based on semi-supervised learning; generating reconstructed curricula based on the basic curriculum; pre-training a learning tendency estimation model that predicts an agent learning tendency pattern of a reinforcement learning model based on the reconstructed curricula; obtaining agent learning tendency information of the reinforcement learning model; and generating a dynamic curriculum control model that reflects the agent learning tendency information by fine-tuning the learning tendency estimation model using a transfer training technique.

The generating of the reconstructed curricula may include generating a plurality of learning units based on the curriculum generation model and determining a learning order between the plurality of learning units; and generating the reconstructed curricula based on the learning order.

The generating of the reconstructed curricula based on the learning order may include evaluating relative difficulty between the learning units and adjusting the learning order according to the evaluated difficulty.

The pre-training may include simulating the reconstructed curricula; and pre-training the learning tendency estimation model based on the simulation result.

The dynamic curriculum control model may determine a learning unit corresponding to an agent of the reinforcement learning model based on the learning tendency information.

The generating of the basic curriculum may include generating learning units based on a combination of labeled data and unlabeled data by the curriculum generation model and evaluating a correlation between them to determine a learning order.

A computer-implemented method of generating a dynamic curriculum control model according to an embodiment may further include obtaining real-time learning tendency information of an agent from an environment of the reinforcement learning model; and inputting the real-time learning tendency information into the dynamic curriculum control model to determine an optimal learning unit corresponding to a corresponding time point.

The generating of the reconstructed curricula may include generating the reconstructed curriculum composed only of learning units in which a difference in difficulty between the plurality of learning units is less than or equal to a set threshold value.

### BRIEF DESCRIPTION OF DRAWINGS

FIG. 1 is a view for explaining reinforcement learning according to an embodiment.

FIG. 2 is a view for explaining a reinforcement learning system according to an embodiment.

FIG. 3 is a block diagram of a curriculum generation module according to an embodiment.

FIG. 4 is a block diagram of a learning tendency pre-training module according to an embodiment.

FIG. 5 is a block diagram of a learning tendency pre-training module according to an embodiment.

FIG. 6 is a block diagram of a deep curriculum reinforcement training module according to an embodiment.

FIG. 7 is a flowchart illustrating a method of generating a dynamic curriculum control model according to an embodiment.

### DETAILED DESCRIPTION

Hereinafter, embodiments of the present invention will be described with reference to the drawings. In the following description, descriptions of a well-known technical configuration in relation to a lead implantation system for a deep brain stimulator will be omitted. For example, descriptions of the configuration/structure/method of a device or system commonly used in deep brain stimulation, such as the structure of an implantable pulse generator, a connection structure/method of the implantable pulse generator and a lead, and a process for transmitting and receiving electrical signals measured through the lead with an external device, will be omitted. Even if these descriptions are omitted, one of ordinary skill in the art will be able to easily understand the characteristic configuration of embodiments of the present invention through the following description.

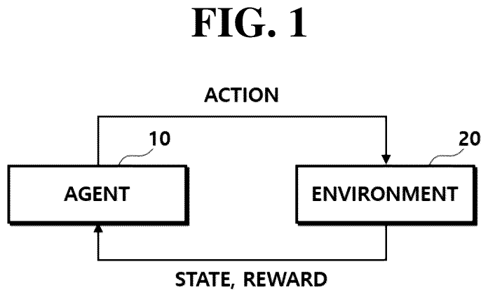

FIG. 1 is a view for explaining reinforcement learning according to an embodiment.

Referring to FIG. 1, a reinforcement learning model according to an embodiment may include an agent 10 and an environment 20 as main components. Reinforcement learning is a machine learning technique in which the agent 10 interacts with the environment 20 and learns optimal actions. Hereinafter, reinforcement learning may be used as a concept including deep reinforcement learning.

The agent 10 observes various states within the environment 20 and selects actions that can be taken in the corresponding states. In this process, the agent 10 changes the environment 20 through actions and receives rewards from the environment 20 accordingly.

The agent 10 continuously learns to maximize this reward and improves future actions based on past experiences. In more detail, the agent 10 learns which actions are more likely to receive a high reward when the agent 10 is in a specific state in the environment 20. This process is repeated over time, and the agent 10 gradually develops an optimal policy.

The core of reinforcement learning is to understand how the agent 10 learns and adjusts its behavior through interactions between the agent 10 and the environment 20. A reward received from the environment 20 is a standard for evaluating the quality of an action selected by the agent 10, and this information plays an important role in learning of the agent 10.

Because the agent 10 performs exploration and exploitation on its own, it is very effective in learning a complex state space. The exploration is a process in which the agent 10 attempts various actions to obtain learning information, and the exploitation is a process of reinforcing an action strategy based on the obtained information.

However, reinforcement learning requires a large amount of exploration as the state space becomes larger. In particular, when the state space is large but a reward signal is sparse, the problem may occur in which an agent does not sufficiently explore various things and excessively focuses on actions with already known rewards. For example, when a workspace of a robot arm is wide, more trial and error is required for motion planning learning. If sufficient exploration is not performed during a learning process, an agent becomes biased toward actions that are given a specific reward.

To solve this problem, a curriculum learning technique may be used. Curriculum is a concept that includes learning units and learning orders designed to enable learners to learn effectively through a series of learning tasks with gradually increasing difficulty. Curriculum learning is a technique that utilizes such curriculum to train neural networks to solve increasingly complex and difficult tasks.

Curriculum learning starts with easy tasks in early stages of learning and gradually increases a difficulty level. When this is applied to reinforcement learning, curriculum learning divides a huge exploration space into several learning tasks, enabling systematic learning from easy to difficult tasks, thereby inducing stable learning. To explain more specifically, in reinforcement learning, it may be difficult for the reinforcement learning agent 10 to design an optimal action policy due to reasons such as a wide exploitation space, sparse reward signals, and a mixture of various tasks. Curriculum may be used to limit an exploration space or divide tasks into sub-items to facilitate an initial action policy design. An action policy constructed in this way becomes a basis for learning more difficult tasks later, preventing a learner from being biased toward receiving a specific reward, thereby enabling more stable and effective learning throughout the entire learning process.

However, conventional curriculum learning has several shortcomings. First, conventional curriculum learning has a limitation in that it cannot reflect feedback from a subject to be trained due to a learning order of curriculum determined in advance. Because the reinforcement learning agent 10 learns with data generated through probabilistic exploration for each learning, it is difficult to effectively control a learning process with a fixed curriculum defined in advance. Furthermore, a difficulty level or correlation between curricula experienced by the agent 10 in an actual learning process may differ significantly from designer's expectations. For example, in robot control learning, simple movements determined easily by a designer may be difficult for the agent 10, and conversely, tasks that appear complicated may be easily acquired by the agent 10. This discrepancy may prevent a fixed curriculum from properly reflecting dynamics of an actual learning process and individual learning patterns of an agent, which may ultimately reduce learning efficiency.

Second, conventional curriculum learning has a dilemma depending on a curriculum generation method. Utilizing domain knowledge of engineers may generate a meaningful curriculum, but it takes a lot of time and money and is difficult to apply to large-scale datasets or complex tasks. On the other hand, automatically generating curricula using artificial intelligence may process large amounts of data quickly, but the generated curricula may lack correlation or may not sufficiently reflect domain specificity.

As described in detail below, a reinforcement learning model according to an embodiment may generate curriculum based on semi-supervised learning so that the agent 10 may learn stably in a wide exploration space, and maximize learning efficiency through a dynamic curriculum adjustment technique. Through this, the reinforcement learning model may overcome limitations of existing curriculum learning and improve learning performance by providing an optimized learning unit that matches a learning tendency of the agent 10. In particular, the reinforcement learning model may effectively reflect engineer's domain knowledge by utilizing a semi-supervised learning technique, and maximize the quantity and quality of learning data by combining labeled data and unlabeled data.

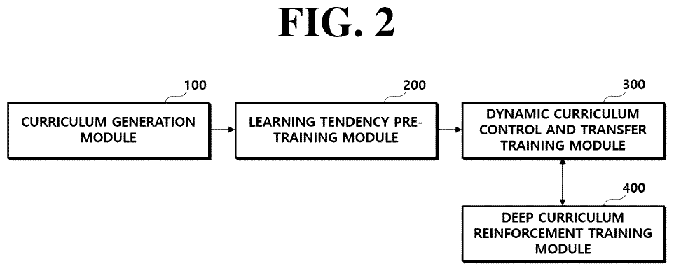

FIG. 2 is a view for explaining a reinforcement learning system according to an embodiment. The descriptions with reference to FIG. 1 may be equally applied to FIG. 2.

Referring to FIG. 2, the reinforcement learning system according to an embodiment may include a curriculum generation module 100, a learning tendency pre-training module 200, a dynamic curriculum control and transfer training module 300, and a deep curriculum reinforcement training module 400 as main components. The term “module” used herein may mean, for example, a unit containing one or a combination of two or more of hardware, software, or firmware. The “module” may be used interchangeably with terms such as unit, logic, logical block, component, or circuit. The “module” may be the smallest unit of integrated parts or a part thereof. The “module” may be a minimum unit or part of one or more functions. The “module” may be implemented mechanically or electronically. For example, the “module” may include at least one of an application-specific integrated circuit (ASIC) chip, field-programmable gate arrays (FPGAs), or a programmable-logic device, known or to be developed in the future, that performs certain operations.

The curriculum generation module 100 according to an embodiment plays a role in constructing a curriculum for reinforcement learning. The curriculum generation module 100 may generate a curriculum based on semi-supervised learning by utilizing labeled data and unlabeled data. The labeled data may be data in which a correct answer (label) is clearly given to each data from among learning data. That is, the labeled data may be data that specifies which category or result the data belongs to in learning, with a target value or output value specified for each data point. The labeled data may suggest the direction of the curriculum by setting a main learning unit and learning order by reflecting the knowledge of a domain expert.

A learning unit may mean individual tasks that an agent needs to learn during a learning process. The learning unit may be an individual learning task that divides problems that an agent needs to solve in reinforcement learning or curriculum learning into smaller units. For example, in robot arm control, individual tasks such as “raising the arm”, “moving to a designated location”, and “grabbing an object” may be learning units.

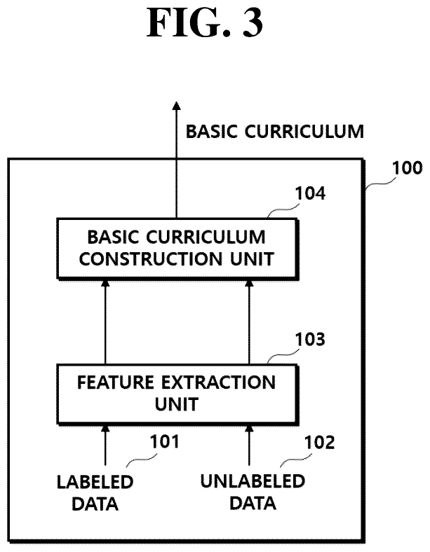

Unlabeled data may be data from among learning data for which no correct answer (label) is provided. In other words, unlabeled data may be data where only input data exists and a target value or output value for it is not specified. The unlabeled data may improve the comprehensiveness of a curriculum by learning patterns of data that could not be expressed due to limited labeled data. The curriculum generation module 100 may build an effective curriculum that includes domain knowledge while minimizing a labeling time of a domain expert by using labeled data and unlabeled data together. A specific configuration and operation of the curriculum generation module 100 will be described in more detail below with reference to FIG. 3.

A reinforcement learning system according to an embodiment may generate a dynamic curriculum control model that may provide an optimized learning unit that is tailored to the learning tendency of an agent, rather than a fixed curriculum. For this purpose, the reinforcement learning system may utilize transfer training. In more detail, the reinforcement learning system may build a basic learning tendency estimation model through the learning tendency pre-training module 200, and generate a dynamic curriculum control model that reflects learning tendency information by fine-tuning a learning tendency estimation model pre-trained by the dynamic curriculum control and transfer training module 300.

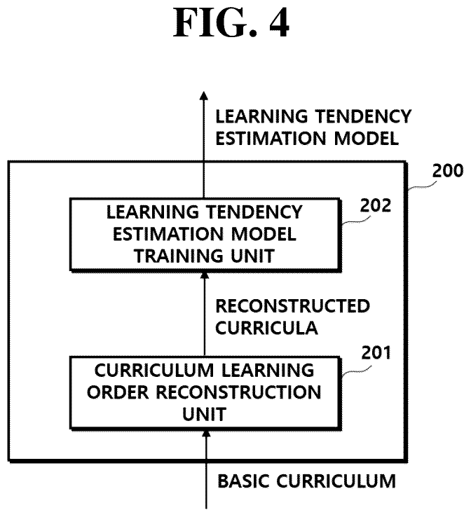

The learning tendency pre-training module 200 may analyze a learning pattern of an agent through various learning orders and generate a learning tendency estimation model that predicts a learning tendency based on this. The learning tendency estimation model may provide an initial prediction of how an agent will learn. Reinforcement learning agents learn with unique trial-and-error data generated through probabilistic exploration in each learning process. This results in the need for a curriculum control model specialized for each agent. Because the learning direction of each agent is different due to differences in initial conditions, random seeds, and exploration strategies, this causes the agents to develop personalized policies based on their own unique experiences. In addition, complex interactions between the agents and environments generate learning patterns that are difficult to predict, and the agents focus on respective points in a learning process due to an exploration-exploitation balance that changes over time. These factors work together to form unique learning requirements and patterns for each agent, so an individualized dynamic curriculum control model is essential. A specific configuration and operation of the learning tendency pre-training module 200 will be described in detail below with reference to FIG. 4.

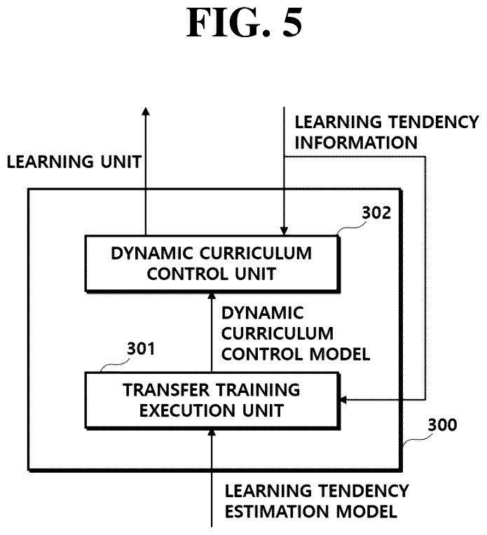

The dynamic curriculum control and transfer training module 300 according to an embodiment may monitor and optimize a curriculum learning process of a deep reinforcement learning agent in real time. The dynamic curriculum control and transfer training module 300 continuously observes a current learning situation of an agent and may perform transfer training based on collected data. Through this, the dynamic curriculum control and transfer training module 300 may generate an individualized dynamic curriculum control model specialized for each agent. The generated dynamic curriculum control model reflects a unique learning pattern of the agent and may dynamically adjust a learning order based on this. A specific configuration and operation of the dynamic curriculum control and transfer training module 300 will be described in detail below with reference to FIG. 5.

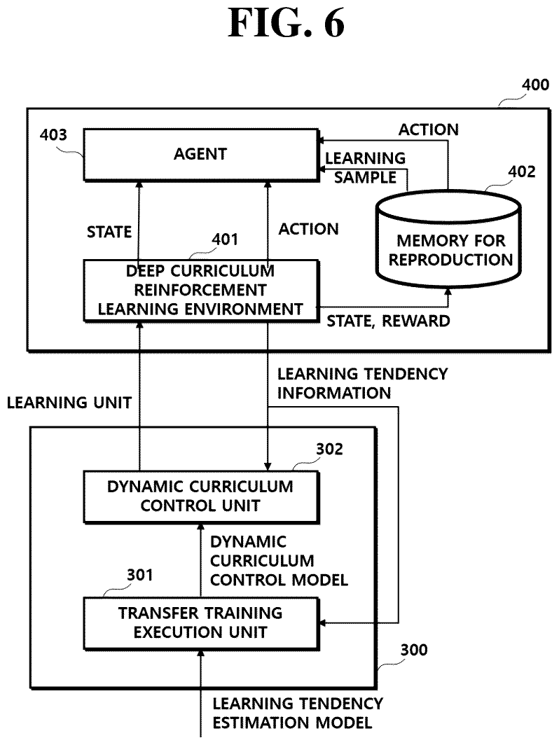

The deep curriculum reinforcement training module 500 may be a module that combines curriculum learning with deep reinforcement learning and allows the deep reinforcement learning agent to interact with an environment and learn. The deep curriculum reinforcement training module 500 may train a reinforcement learning model by utilizing the dynamic curriculum control model. In more detail, the deep curriculum reinforcement training module 500 may obtain real-time learning tendency information of an agent from an environment of the reinforcement learning model and input the real-time learning tendency information into the dynamic curriculum control model to determine an optimal learning unit corresponding to a corresponding time. A specific configuration and operation of the deep curriculum reinforcement training module 500 will be described in more detail below with reference to FIG. 6.

FIG. 3 is a block diagram of a curriculum generation module according to an embodiment. The descriptions with reference to FIGS. 1 and 2 may be equally applied to FIG. 3.

Referring to FIG. 3, the curriculum generation module 100 according to an embodiment may include a feature extraction unit 103 and a basic curriculum construction unit 104. However, the elements, shown in FIG. 3, are not essential elements. The curriculum generation module 100 may be implemented by using more or less elements than those shown in FIG. 3. In addition, terms such as “ . . . unit”, “-er”, and “-or” refer to units that perform at least one function or operation, and the units may be implemented as hardware or software or as a combination of hardware and software.

Labeled data 101 according to an embodiment is data that a specific subject (e.g., an engineer) directly performed labeling, contains domain knowledge, and may be useful for initial learning because it contains clear answers. The labeled data 101 guarantees the performance of an initial model and may contribute to constructing a curriculum based on domain knowledge.

Unlabeled data 102 according to an embodiment is an unlabeled dataset and may be used together with labeled data through a semi-supervised learning technique. This allows more learning data to be utilized. The unlabeled data 102 may contribute to improving the generalization ability of a model by providing a large amount of learning data.

The feature extraction unit 103 according to an embodiment extracts meaningful features from the labeled data 101 and the unlabeled data 102. Through this, the feature extraction unit 103 supports a learning model to understand and learn data more effectively, and an extracted feature may be utilized in designing a curriculum in the basic curriculum construction unit 104.

The basic curriculum construction unit 104 according to an embodiment may train a curriculum generation model using a semi-supervised learning technique by utilizing characteristics of the labeled data 101 and the unlabeled data 102. A curriculum generation model generated through the above process may extract a number of learning units and calculate relative difficulty between the learning units. For example, the curriculum generation model may generate a basic curriculum by generating learning units based on a combination of labeled data and unlabeled data, evaluating a correlation between them, and determining a learning order.

FIG. 4 is a block diagram of a learning tendency pre-training module according to an embodiment. The descriptions with reference to FIGS. 1 to 3 may be equally applied to FIG. 4.

Referring to FIG. 4, the learning tendency pre-training module 200 according to an embodiment may include a curriculum learning order reconstruction unit 201 and a learning tendency estimation model training unit 202. However, the elements, shown in FIG. 4, are not essential elements. The learning tendency pre-training module 200 may be implemented by using more or less elements than those shown in FIG. 4.

In order for a reinforcement learning agent to fairly observe how learning units in a curriculum are related to each other, it is desirable to generate multiple cases by reconstructing a learning order of the curriculum. The curriculum learning order reconstruction unit 201 may operate based on a basic curriculum provided by the basic curriculum construction unit 104 of the curriculum generation module 100. In more detail, the curriculum learning order reconstruction unit 201 according to an embodiment may change a learning order of the basic curriculum through a series of rules or a random method to generate cases of various learning orders. Multiple curriculum variations generated through this process provide a basis for analyzing an agent's learning pattern from various angles, and ultimately enable a more accurate and comprehensive understanding of correlations between learning units.

Alternatively, the curriculum learning order reconstruction unit 201 may evaluate relative difficulty between learning units and adjust a learning order according to the evaluated difficulty. For example, the curriculum learning order reconstruction unit 201 may generate a reconstructed curriculum composed only of learning units in which a difference in difficulty between a plurality of learning units is less than or equal to a set threshold value. When generating the reconstructed curriculum, the curriculum learning order reconstruction unit 201 may include a process of limiting a difference in difficulty between learning units to a set threshold value or less, thereby preventing the curriculum from being composed of learning units that are overly difficult or overly easy. Through this, a curriculum that allows an agent to learn more stably and efficiently may be provided. However, an operation of the curriculum learning order reconstruction unit 201 is not limited to the example described above. For example, when a difference in difficulty between learning units exceeds a threshold, the curriculum learning order reconstruction unit 201 may rearrange an order according to difficulty instead of removing the corresponding unit or provide additional support materials so that a learner may effectively learn all the units.

The learning tendency estimation model training unit 202 may build a model that predicts a learning pattern of the reinforcement learning agent. The learning tendency estimation model training unit 202 may repeatedly simulate success/failure of deep curriculum reinforcement learning by utilizing various learning orders obtained from the curriculum learning order reconstruction unit 201. The learning tendency estimation model training unit 202 may systematically analyze a learning tendency shown by an agent in each learning process and train a learning tendency estimation model based on data obtained by this. As an algorithm used for learning, various machine learning algorithms based on supervised learning and reinforcement learning may be selected, and as data used for learning, data such as a success rate trend for each learning unit may be selected when deep curriculum reinforcement learning is performed by applying a series of learning orders.

FIG. 5 is a block diagram of a learning tendency pre-training module according to an embodiment. The descriptions with reference to FIGS. 1 to 4 may be equally applied to FIG. 5.

Referring to FIG. 5, the dynamic curriculum control and transfer training module 300 according to an embodiment may include a transfer training execution unit 301 and a dynamic curriculum control unit 302. However, the elements, shown in FIG. 5, are not essential elements. The dynamic curriculum control and transfer training module 300 may be implemented by using more or less elements than those shown in FIG. 5.

The transfer training execution unit 301 according to an embodiment may perform transfer training based on a basic model generated from the learning tendency pre-training module 200 to generate a dynamic curriculum control model. The transfer training execution unit 301 may fine-tune the basic model by utilizing an actual learning tendency of an agent provided from a deep curriculum reinforcement learning environment 401 as a learning sample, thereby generating a learning tendency estimation model that is suitable for characteristics of each agent. The generalized basic model (learning tendency estimation model) through this process may be adjusted to reflect a unique learning pattern and characteristics of each agent.

The dynamic curriculum control unit 302 according to an embodiment receives agent learning tendency information from the deep curriculum reinforcement learning environment 401 based on the dynamic curriculum control model received from the transfer training execution unit 301 and transmits a learning unit with the highest learning efficiency at the point in time to the deep curriculum reinforcement learning environment 401, thereby dynamically controlling a learning order of a curriculum.

FIG. 6 is a block diagram of a deep curriculum reinforcement training module according to an embodiment. The descriptions with reference to FIGS. 1 to 5 may be equally applied to FIG. 6.

Referring to FIG. 6, the deep curriculum reinforcement training module 400 may include the deep curriculum reinforcement learning environment 401, a memory for reproduction 402, and an agent 403. However, the elements, shown in FIG. 6, are not essential elements. The deep curriculum reinforcement training module 400 may be implemented by using more or less elements than those shown in FIG. 6.

The deep curriculum reinforcement learning environment 401 according to an embodiment may provide an environment in which learning can be performed by interacting with the agent 403. The agent 403 learns behavior based on a state and reward in the deep curriculum reinforcement learning environment 401 and may adapt to various situations. The deep curriculum reinforcement learning environment 401 may improve the efficiency of learning by limiting an exploration space of the agent 403 or adjusting a reward function according to a learning unit of a curriculum. The deep curriculum reinforcement learning environment 401 may provide an individualized environment to the agent 403 by utilizing a learning unit received in real time from the dynamic curriculum control unit 302. Through this, the agent 403 may have the ability to learn more efficiently and effectively.

The memory for reproduction 402 according to an embodiment may store transactions on a state, action, reward, and next state of the agent 403 and provide data necessary for training of a policy network. The memory for reproduction 402 may effectively manage learning data to improve learning efficiency.

The agent 403 according to an embodiment learns an optimal action policy in the deep curriculum reinforcement learning environment 401 and may improve learning performance by using data in the memory for reproduction 402. The agent 403 may continuously learn, adapt to new situations, and optimize performance through interaction with the deep curriculum reinforcement learning environment 401.

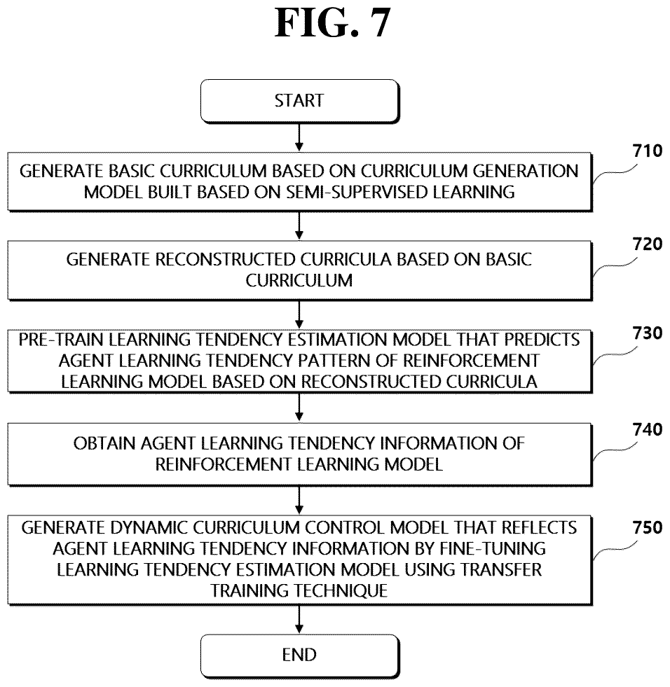

FIG. 7 is a flowchart illustrating a method of generating a dynamic curriculum control model according to an embodiment. The descriptions with reference to FIGS. 1 to 6 may be equally applied to FIG. 7. Operations of FIG. 7 may be performed in the illustrated order and manner, but the order of some operations may be changed or some operations may be omitted without departing from the spirit and scope of the illustrated embodiment. A number of operations shown in FIG. 7 may be performed in parallel or concurrently.

A reinforcement learning system according to an embodiment may adjust a curriculum in real time reflecting agent characteristics. The reinforcement learning system may generate an individualized curriculum control model that matches a learning pattern and characteristics of an agent, and may adjust a curriculum in real time during a learning process to provide an optimal learning path that matches an agent's learning situation.

The reinforcement learning system according to an embodiment may generate an efficient curriculum based on domain knowledge. The reinforcement learning system effectively applies engineer's domain knowledge and maintains high performance even in a large-scale dataset by combining labeled data and unlabeled data through semi-supervised learning. This may contribute to maintaining high learning performance while reducing labeling costs.

In more detail, in operation 710, the curriculum generation module 100 according to an embodiment may generate a basic curriculum based on a curriculum generation model built based on semi-supervised learning. The curriculum generation module 100 may generate learning units based on the curriculum generation model combining labeled data and unlabeled data, and determine a learning order by evaluating a correlation between them.

In operation 720, the learning tendency pre-training module 200 according to an embodiment may generate reconstructed curricula based on the basic curriculum. The learning tendency pre-training module 200 may generate a plurality of learning units based on the curriculum generation model, determine a learning order between the plurality of learning units, and generate reconstructed curricula based on the learning order. The learning tendency pre-training module 200 may evaluate relative difficulty between learning units and adjust a learning order according to the evaluated difficulty to generate reconstructed curricula.

In operation 730, the learning tendency pre-training module 200 according to an embodiment may pre-train a learning tendency estimation model that predicts an agent learning tendency pattern of a reinforcement learning model based on the reconstructed curricula. The learning tendency pre-training module 200 may simulate the reconstructed curricula and pre-train the learning tendency estimation model based on simulation results.

In operation 740, the dynamic curriculum control and transfer training module 300 according to an embodiment may obtain agent learning tendency information of the reinforcement learning model.

In operation 750, the dynamic curriculum control and transfer training module 300 according to an embodiment may generate a dynamic curriculum control model that reflects the agent learning tendency information by fine-tuning the learning tendency estimation model using a transfer training technique.

The embodiments described above may be implemented by hardware components, software components, and/or any combination thereof. For example, the devices, the methods, and components described in the embodiments may be implemented by using general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other devices which may execute and respond to instructions. A processing apparatus may execute an operating system (OS) and a software application executed in the OS. Also, the processing apparatus may access, store, operate, process, and generate data in response to the execution of software. For convenience of understanding, it may be described that one processing apparatus is used. However, one of ordinary skill in the art will understand that the processing apparatus may include a plurality of processing elements and/or various types of processing elements. For example, the processing apparatus may include a plurality of processors or a processor and a controller. Also, other processing configurations, such as a parallel processor, are also possible.

The software may include computer programs, code, instructions, or any combination thereof, and may construct the processing apparatus for desired operations or may independently or collectively command the processing apparatus. In order to be interpreted by the processing apparatus or to provide commands or data to the processing apparatus, the software and/or data may be permanently or temporarily embodied in any types of machines, components, physical devices, virtual equipment, computer storage mediums, or transmitted signal waves. The software may be distributed over network coupled computer systems so that it may be stored and executed in a distributed fashion. The software and/or data may be recorded in a computer-readable recording medium.

A method according to an embodiment may be implemented as program instructions that can be executed by various computer devices, and recorded on a computer-readable recording medium. The computer-readable recording medium may include program instructions, data files, data structures or a combination thereof. Program instructions recorded on the medium may be particularly designed and structured for embodiments or available to one of ordinary skill in a field of computer software. Examples of the computer-readable recording medium include magnetic media, such as a hard disc, a floppy disc, and magnetic tape; optical media, such as a compact disc-read only memory (CD-ROM) and a digital versatile disc (DVD); magneto-optical media, such as floptical discs; and hardware devices specially configured to store and execute program instructions, such as ROM, random-access memory (RAM), a flash memory, etc. Program instructions may include, for example, high-level language code that can be executed by a computer using an interpreter, as well as machine language code made by a complier.

In concluding the detailed description, those of ordinary skill in the art will appreciate that many variations and modifications may be made to the embodiments without substantially departing from the principles of embodiments of the present invention. Therefore, the disclosed embodiments of the invention are used in a generic and descriptive sense only and not for purposes of limitation.

What is claimed is:

1. A computer-implemented method of generating a dynamic curriculum control model, the method comprising:
generating a basic curriculum based on a curriculum generation model built based on semi-supervised learning;
generating reconstructed curricula based on the basic curriculum;
pre-training a learning tendency estimation model that predicts an agent learning tendency pattern of a reinforcement learning model based on the reconstructed curricula;
obtaining agent learning tendency information of the reinforcement learning model; and
generating a dynamic curriculum control model that reflects the agent learning tendency information by fine-tuning the learning tendency estimation model using a transfer training technique.

2. The method of claim 1, wherein the generating of the reconstructed curricula comprises:
generating a plurality of learning units based on the curriculum generation model and determining a learning order between the plurality of learning units; and
generating the reconstructed curricula based on the learning order.

3. The method of claim 2, wherein the generating of the reconstructed curricula based on the learning order comprises:
evaluating relative difficulty between the learning units and adjusting the learning order according to the evaluated relative difficulty.

4. The method of claim 2, wherein the pre-training comprises:
simulating the reconstructed curricula; and
pre-training the learning tendency estimation model based on a result of the simulation.

5. The method of claim 1, wherein the dynamic curriculum control model is configured to:
determine a learning unit corresponding to an agent of the reinforcement learning model based on the learning tendency information.

6. The method of claim 1, wherein the generating of the basic curriculum comprises:
generating learning units based on a combination of labeled data and unlabeled data by the curriculum generation model and evaluating a correlation between them to determine a learning order.

7. A non-transitory computer-readable medium having a computer program stored thereon that is executable by one or more processors for executing the method of claim 1 in combination with hardware.
